(19) United States
(12) Patent Application Publication
(10) Pub. No.: US 2013/0135169 A1
(43) Pub. Date: May 30, 2013

(54) ANTENNA

(71) Applicant: Sarantel Limited, Wellingborough (GB)

(72) Inventor: Andrew Robert Christie, Mawsley (GB)

(73) Assignee: SARANTEL LIMITED, Wellingborough (GB)

(21) Appl. No.: 13/682,557

(22) Filed: Nov. 20, 2012

Related U.S. Application Data
(60) Provisional application No. 61/564,227, filed on Nov. 28, 2011.

(30) Foreign Application Priority Data
Nov. 25, 2011 (GB) 1120466.6

(51) Int. Cl. H01Q 1/38; H01Q 1/50; H01P 11/00; H01Q 1/52

(52) U.S. Cl. CPC H01Q 1/38; H01Q 1/526; H01Q 1/50; H01P 11/00
USPC 343/841; 343/895; 343/860; 29/600

(57) ABSTRACT

This application relates to antennas including, for example, an antenna for operation at a frequency in excess of 200 MHz comprising: an insulative substrate having a central axis, an axial passage extending therethrough and an outer substrate surface which extends around the axis; a three-dimensional antenna element structure including at least one pair of axially coextensive elongate conductive antenna elements on or adjacent the outer substrate surface; and an axial feeder structure which extends through the passage and comprises an elongate laminate board wherein the laminate board proximal end portion includes lateral extensions projecting in opposite lateral directions, and wherein, adjacent the laminate board proximal end portion, the substrate has recesses on opposite sides of the axis which receive at least edge parts of the said lateral extensions of the laminate board proximal end portion.

### CROSS-REFERENCE TO RELATED APPLICATIONS

This application claims the benefit of U.S. Provisional Application No. 61/564,227, filed on Nov. 28, 2011, and entitled “ANTENNA”, and also claims priority to United Kingdom Patent Application 1120466.6, filed on Nov. 25, 2011, and entitled “AN ANTENNA”, both of which are hereby incorporated herein by reference.

### FIELD

This application relates to an antenna for operation at a frequency in excess of 200 MHz, particularly to such an antenna having an axial feed structure comprising an elongate laminate board extending through a passage in an insulative substrate with antenna elements on or adjacent an outer surface of the substrate. The disclosed technology also includes a method of making a multiple-band antenna.

### BACKGROUND

A dielectrically-loaded antenna with a laminate board axial feed structure is disclosed in U.S. Published Patent Application No. 2011/0221650 (U.S. application Ser. No. 13/014,962, filed Jan. 27, 2011). Included in the antennas disclosed in this document is a quadrifilar helical backfire antenna having a cylindrical dielectric core, conductive helical radiating elements plated on the outer cylindrical core surface portion, which elements are fed from a distal end of an axially extending elongate laminate board feed structure. The feed structure comprises an elongate transmission line section acting as a feed line which extends through an axial passage in the core from a proximal core surface portion to a distal core surface portion, and an antenna connection section in the form of an integrally formed proximal extension of the transmission line section the width of which, in the plane of the laminate board, is greater than the width of the passage. The antenna elements are coupled to the transmission feed line via an impedance matching section. The contents of this published application are expressly incorporated in the present application by reference.

### SUMMARY

It is an object of certain embodiments of the disclosed technology to provide an improved antenna with a laminate board feed structure.

According to one aspect of the disclosed technology, an antenna for operation at a frequency in excess of 200 MHz comprises: an insulative substrate having a central axis, an axial passage extending therethrough and an outer substrate surface which extends around the axis; a three-dimensional antenna element structure including at least one pair of axially coextensive elongate conductive antenna elements on or adjacent the outer substrate surface; and an axial feeder structure which extends through the passage and comprises an elongate laminate board having a proximal end portion for connection to host equipment circuitry, an intermediate portion including a transmission line, and a distal end portion coupled to the antenna elements; wherein the laminate board proximal end portion is wider than the intermediate portion in that it includes lateral extensions projecting in opposite lateral directions, and wherein, adjacent the laminate board proximal end portion, the substrate has recesses on opposite sides of the axis which receive at least edge parts of the lateral extensions of the laminate board proximal end portion. In a preferred antenna embodiment, the substrate comprises a dielectric core of solid material which has a relative dielectric constant greater than 5 and occupies the major part of the interior volume defined by the core outer surface. The core outer surface preferably comprises oppositely directed distal and proximal outer surface portions and a side outer surface portion which extends between the distal and proximal outer surface portions, with the axial passage extending through the core from the distal surface portion to the proximal surface portion. In this preferred embodiment, the recesses are grooves in the proximal outer surface portion of the core.

Certain embodiments of the disclosed technology are particularly applicable to an antenna for receiving and/or transmitting circularly polarised waves. The core is preferably cylindrical, the above-mentioned antenna elements comprising helical elements on the cylindrical side outer surface of the core. As in the above-referenced U.S. Published Application No. 2011/0221650, the core side surface portion also carries a plated proximal sleeve linking proximal ends of the helical elements, and the proximal outer surface portion and the grooves have a conductive coating connected to the sleeve. The feeder structure transmission line includes a conductor connected to this proximal surface portion conductive coating via electrical interconnection of a conductive layer on at least one of the laminate board lateral extensions as well as the conductive layer in the respective groove housing that lateral extension. Locating the lateral extensions of the laminate board proximal end portion in the grooves fixes the rotational position of the feed structure laminate board about the substrate central axis and, therefore, with respect to the antenna element structure. With this property in mind, it is preferable that the width of at least one of the recesses matches the thickness of the laminate board proximal end portion.

In the preferred feed structure, the intermediate portion of the laminate board comprises an inner conductive layer forming an elongate inner conductor of the transmission line and, on opposite sides of the inner conductive layer, the intermediate portion has interconnected shield conductor layers forming elongate shield conductors which are axially coextensive with the inner conductor so as to form a shield around the inner conductor.

As part of the antenna element structure, there may be an annular interconnecting conductor on or adjacent the core outer surface (e.g. in the form of the above sleeve) that links the proximal ends of the elongate conductive elements. The feeder shield conductors are connected to the annular interconnecting conductor at an axial position corresponding to that of the base of the respective recess. Connecting the annular interconnecting conductor to the feeder using a conductor in the base of the recess rather than at the axial position of the proximal outer surface portion of the core has the effect of shortening the conductive path lengths between the proximal ends of the elongate conductive antenna elements and their connection to the feeder and, additionally, the operative length of an outer surface of the feeder between that connection and its distal connection to the antenna elements. This raises the frequency of resonant modes of the antenna associated with a composite conductive path including such conductors.

In the case of the substrate comprising a high dielectric constant solid core, the dimensions of the axial passage extending through the core from the distal surface portion to the proximal surface portion, and those of the shield conductors of the feeder are such that the shield conductors are spaced from the wall of the passage. This also reduces the relevant electrical length of the feeder and increases the frequencies of the associated resonant modes.

In the preferred embodiment, the antenna has first and second operating frequencies in excess of 200 MHz respectively associated with first and second modes of resonance. The first mode is characterised by currents passing around the annular interconnecting conductor and rotational phasing of the currents in the elongate conductive antenna elements around the antenna axis, producing a rotating dipole in the electric field. The second mode is a coaxial monopole mode in which currents in the elongate elements are spatially in phase with each other.

The frequency of the first mode of resonance is determined primarily by the electrical lengths of the elongate, preferably helical, antenna elements, whereas that of the second mode of resonance is determined by the electrical lengths of the elongate antenna elements and that of the conductive path formed between the proximal ends of the elongate elements and the distal end of the transmission line, which includes the feeder shield. In the preferred antenna, the first mode of resonance is associated with axially directed circularly polarised waves and the second mode of resonance is associated with linearly polarised waves, the plane of polarisation containing the antenna axis. The second operating frequency is higher than the first.

Such an antenna is suited, for instance, to dual-service operation at the GPS L1 frequency, 1575 MHz and at the Wireless LAN and Bluetooth frequency in the region of 2450 MHz.

Typically, the axial depth of the substrate is greater than its lateral extent so that, in the case of a cylindrical substrate, the ratio of the substrate length to its diameter is greater than 1 and, preferably, between 1.2 and 2.5. It is preferred that the position of the annular conductive path linking the proximal ends of the elongate conductive elements, whether in the form of a simple metallised ring of the rim of a conductive sleeve, should be at a distance of between 15% to 30% of the overall axial length of the substrate from the proximal periphery of the outer substrate surface. Typically, the depth of the slots or recesses is less than 50% of this distance. A slot or recess depth of greater than 0.5 mm is preferred.

In the case of a dielectrically-loaded antenna in which the substrate is a solid core, the relative dielectric constant of the core material is preferably greater than 20 with a figure in the region of 80 being most preferred. Typically, the diameter of the core, in the case of a cylindrical core, is between 5 and 15 mm. The preferred antenna described herein has a diameter in the region of 7.5 mm and an axial length of about 12 mm. With a relative dielectric constant of around 80, such an antenna is particularly suitable for dual-service operation at the frequencies given above.

Interconnections between the feed structure and the antenna elements may further comprise a lateral laminate board part connected to the above-mentioned elongate laminate board and extending laterally outwardly from the distal end of the axial passage, conductors on the lateral laminate board part coupling the antenna elements to the transmission line. In particular, the lateral laminate board part may comprise a laminate board oriented perpendicularly to the central axis. Impedance matching between the transmission line and the antenna elements is preferably performed by a network associated with a distal region of the feeder structure.

According to another aspect of the disclosed technology, a method of making a multiple band antenna for operation at frequencies in excess of 200 MHz comprises: providing a plurality of antenna bodies each of which comprises (i) an insulative antenna substrate having a central axis, an axial passage extending therethrough, and an outer substrate surface extending around the axis, the outer substrate surface having distal periphery and proximal periphery, (ii) a three-dimensional antenna element structure including at least one pair of axially coextensive elongate conductive antenna elements on the outer substrate surface, and (iii) a linking conductor encircling the axis on the outer substrate surface and interconnecting proximal ends of the antenna elements, wherein the substrate has proximal recesses on opposite sides of the axis, the recesses extending into the linking conductor to reduce its effective axial extent, wherein the plurality of antenna bodies have the same axial extent, as determined by the distance between the distal and proximal peripheries, but recesses of different respective depths; providing a plurality of feeder structures each comprising an elongate laminate board having a proximal end portion for connection to host equipment circuitry, an intermediate portion including a transmission line and dimensioned to lie in the substrate passage, and a distal end portion for coupling to antenna elements, the proximal end portion having lateral extensions projecting in opposite lateral directions, wherein the plurality of feeder structures have intermediate portions of different lengths; selecting one of the antenna bodies and one of the feeder structures; inserting the selected feeder structure into the axial passage of the selected antenna body with the lateral extensions of the laminate board proximal end portion seated in the proximal recesses of the antenna body substrate; and forming electrical connections between the antenna elements and the laminate board distal end portion and between the linking conductor and the lateral extensions of the laminate board proximal end portion. The elongate laminate boards of the feeder structures are preferably all of the same length, the proximal end portions being of different axial lengths. In this case, the selection of a feeder structure for each antenna depends on the recess depth of the selected antenna body. In this way, the conductive path length associated with the linearly polarised mode of resonance can be altered without altering the outside dimensions of the assembled antenna and, therefore, without altering the mounting and connection requirements of the antennas.

The disclosed technology will be described below by way of example with reference to the drawings.

### BRIEF DESCRIPTION OF THE DRAWINGS

In the drawings:

FIGS. 1A and 1B are perspective views of a first antenna in accordance with the disclosed technology viewed, respectively, from below and from one side and above and one side;

FIGS. 1C and 1D are perspective views of a second antenna in accordance with the disclosed technology viewed, respectively, from below and one side and from above and one side;

FIGS. 2A and 2B are exploded views of components of the antenna of FIGS. 1A and 1B, viewed respectively from the same directions as in FIGS. 1A and 1B;

FIGS. 2C and 2D are exploded views of components of the antenna of FIGS. 1C and 1D viewed, respectively, from the same directions as in FIGS. 1C and 1D;

FIG. 3 is an exploded perspective view of a multiple-layer laminate board forming part of an antenna feed structure; and

FIG. 4 is a partly sectioned side detail of the antenna of FIGS. 1A and 1B.

### DETAILED DESCRIPTION

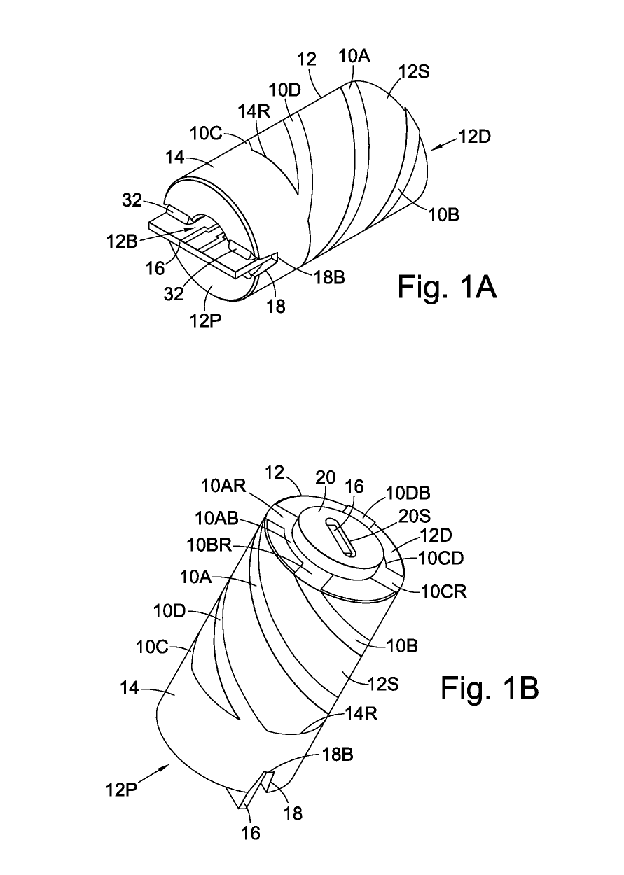

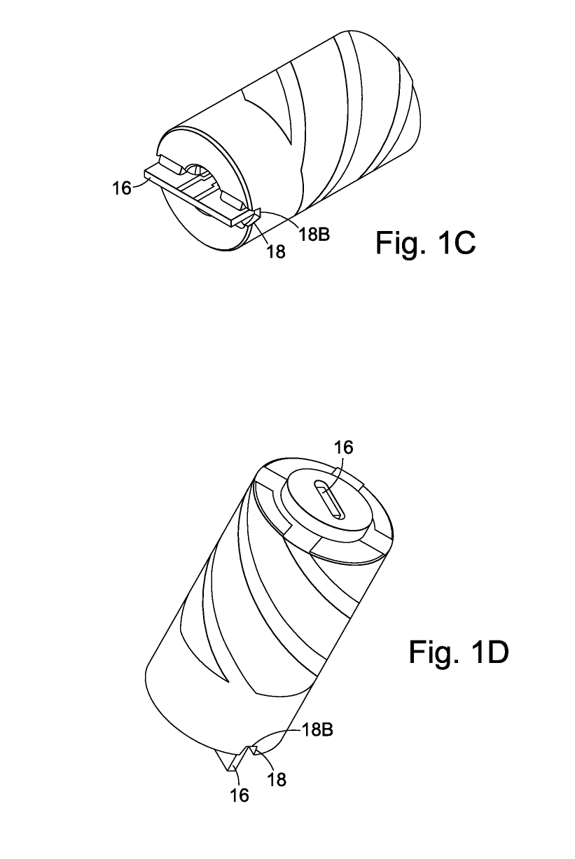

Referring to FIGS. 1A and 1B, a dielectrically-loaded backfire helical antenna in accordance with an embodiment of the disclosed technology has an antenna element structure with four axially coextensive helical tracks 10A, 10B, 10C, 10D plated or otherwise metallised on the cylindrical side outer surface portion 12S of a cylindrical ceramic core 12. The relative dielectric constant of the ceramic material of the core is typically greater than 20. A barium-samarium-titanate-based material, having a relative dielectric constant of 82 is especially suitable. With a total core length of 12 mm and a diameter of 7.5 mm, the antenna has frequencies of operation at 1575 MHz and 2450 MHz, as will be described below.

The core 12 has a central passage 12B, centred on the axis of the cylinder and in the form of a bore 12B extending through the core from a distal end surface portion 12D to a proximal end surface portion 12P. Both of these end surface portions are planar faces extending transversely and perpendicularly with respect to the core axis. They are oppositely directed in that one is directed distally and the other proximally.

On the distal end surface portion 12D of the core, the antenna element structure includes four plated or otherwise metallised radial connection elements 10AR, 10BR, 10CR, 10DR, each connected to one of the antenna elements 10A-10D. Arcuate interconnections 10AB, 10CD interconnect the radial connection elements.

Encircling a proximal end portion of the core 12 is a plated or otherwise metallised conductive sleeve 20 which is conductively continuous with a plated or otherwise metallised conductive covering of the proximal end surface portion 12P of the core. The rim 20U of the sleeve 20 forms an annular interconnection of the proximal ends of the helical antenna elements 10A-10D.

Housed in the axial bore 12B of the core is a feeder structure in the form of a laminate board 16 having a plurality of conductive layers and a plurality of insulative layers as will be described below. At the proximal end of the bore 12B, the laminate board 16 is received in grooves 18 opening out in the proximal end surface portion 12P. In this example the grooves 18 also intersect the cylindrical outer surface 12S. At the other, distal end of the bore 12B, the laminate board 16 projects beyond the distal end surface portion 12D and is received in a slot 20S of a disc-shaped lateral laminate board part 20 of the feeder structure. Lateral laminate board part 20 overlies the core distal end surface portion 12D and is of a lateral extent sufficient to overlie, as well, the arcuate interconnecting conductors 10AB, 10CD of the antenna element structure.

A second antenna embodiment, as shown in FIGS. 1C and 1D, has the same features as those of the first antenna described above with reference to FIGS. 1A and 1B. However, in the second antenna, the depth of the grooves 18 is less than in the first antenna, and the laminate board 16 is correspondingly modified, as hereinafter described.

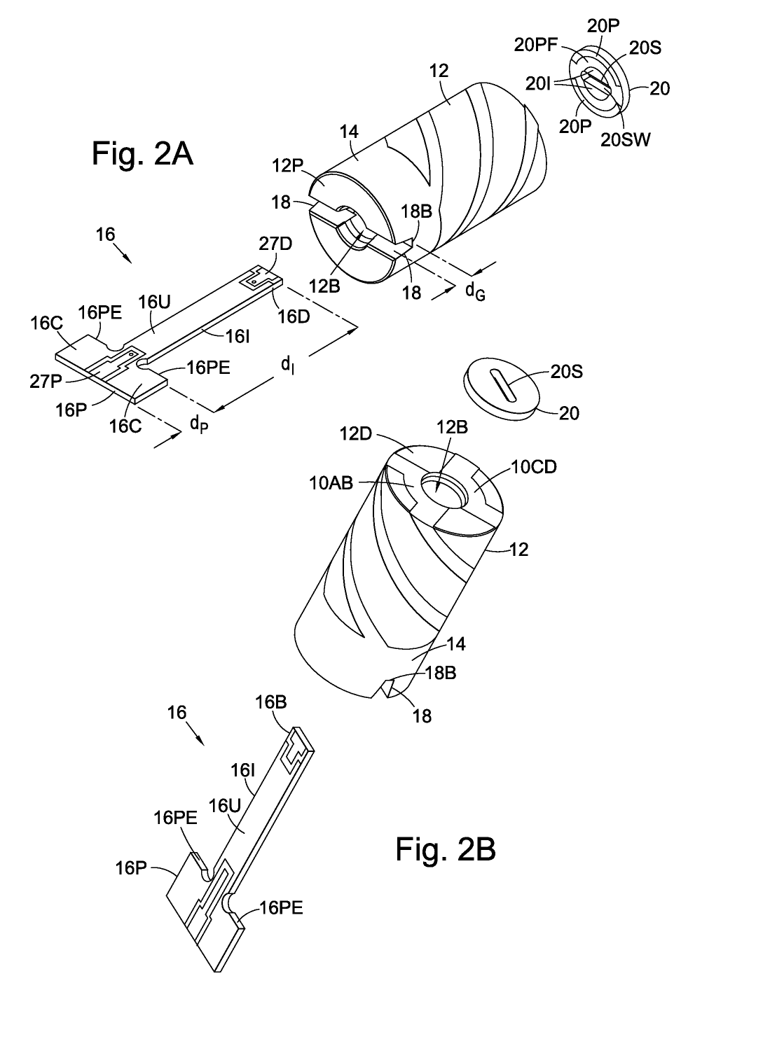

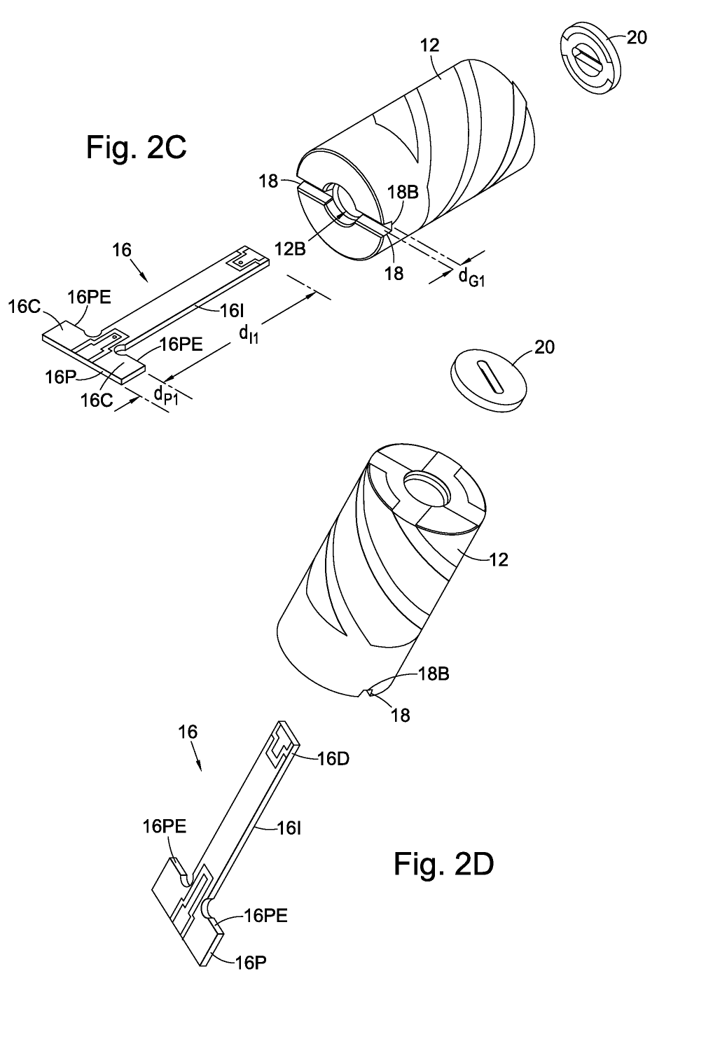

Further details of both antennas and the differences between them are visible in the exploded views of FIGS. 2A to 2D. Referring, firstly, to FIGS. 2A and 2B, the elongate laminate board 16 of the feeder structure has a proximal end portion 16P for connection to host equipment circuitry, an intermediate portion 16I which forms a shielded transmission line, and a distal end portion 16D to be received in the slot 20S of the lateral laminate board part 20.

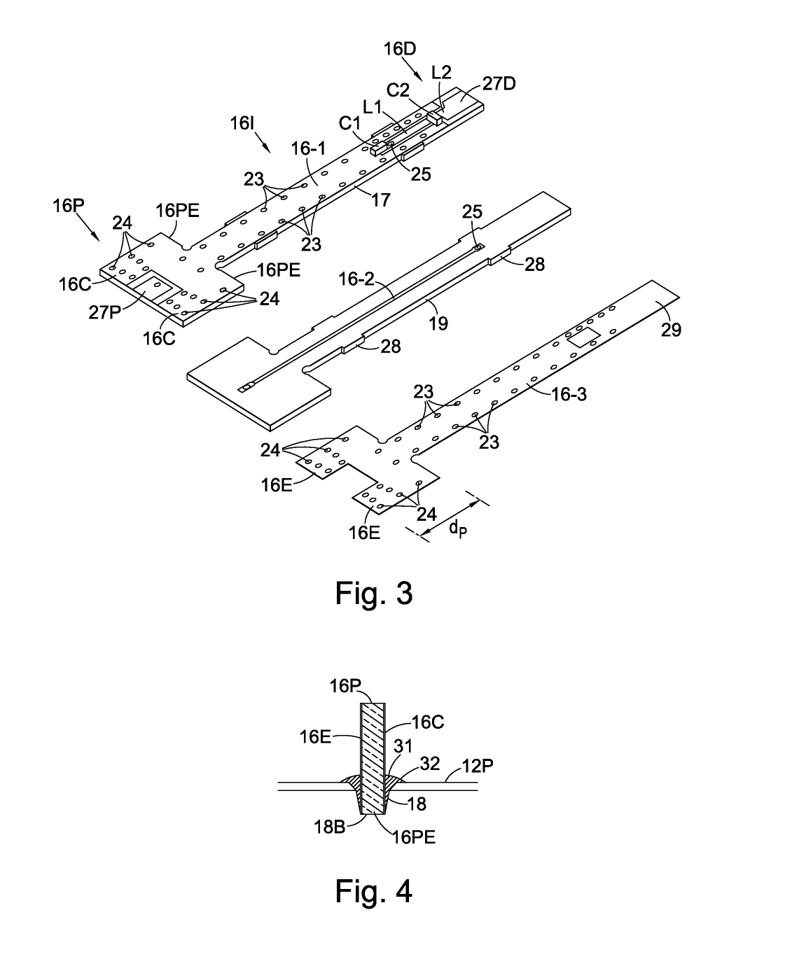

The elongate laminate board 16 has three conductive layers, only one of which appears in FIGS. 2A and 2B. This first conductive layer is exposed on an upper surface 16U of the board 16. Referring to the exploded view of FIG. 3, the first conductive layer 16-1 extends the full length of the intermediate portion 16I and substantially the full width, too. On the proximal end portion 16P of the board 16, the conductive layer 16-1 forms proximal contact areas 16C which are electrically continuous with that part of the conductive layer which is on the intermediate portion 16I.

The second, intermediate conductive layer 16-2 of the laminate board 16, separated from the first conductive layer by an insulative layer 17, is formed as a narrow elongate feed line conductor positioned centrally between the edges of the intermediate portion 16I. The third, lower conductive layer 16-3 has a similar configuration to the upper conductive layer 16-1 in that it extends the full length of the intermediate portion 16I and is electrically continuous with contact areas 16E on the proximal end portion 16P. It is insulated from the intermediate conductive layer 16-2 by a second insulative layer 19. Adjacent each edge of the board intermediate portion 16I is a line of plated vias 23 interconnecting the upper conductive layer 16-1 and the lower conductive layer 16-3 along opposite sides of the inner conductor formed by the intermediate layer 16-2. As a result, the combination of the three conductive layers 16-1, 16-2, 16-3 form a quasi-coaxial shielded transmission line in the laminate intermediate portion 16I. In this instance, the characteristic impedance of the transmission line is 50 ohms.

Plated vias 24 between the contact areas 16C, 16E on opposite faces of the board proximal end portion 16P interconnect these contact areas.

At each end of the inner conductor formed by intermediate layer 16-2, there is a plated via 25 connecting the inner conductor to proximal and distal feed line connection areas 27P, 27D on the upper surface 16U (see FIGS. 2A and 2B) of the elongate laminate board 16.

The laminate board shown in FIG. 3 is a variant inasmuch as it has an impedance matching network in its distal end portion. This is a two-pole network having two shunt capacitors C1, C2 as discrete surface-mount capacitors. The network also contains two series inductances L1, L2 constituted by plated tracks of the conductive layer 16-1.

Still referring to FIG. 3, each longitudinal edge of the intermediate board portion 16I has spaced-apart nibs 28 which increase the width of the intermediate section at their respective axial locations to match the diameter of the bore 12B (FIGS. 2A, 2B) so that the intermediate laminate board portion 16I is an interference fit in the bore with the edges of the elongate shield conductors formed by the upper and lower conductive layers 16-1, 16-3 spaced from the wall of the bore.

Referring generally to FIGS. 2A, 2B and 3, it will be noted that the laminate board proximal end portion 16P is significantly wider than the intermediate portion 16I in that it includes lateral extensions or ears projecting in opposite lateral directions with respect to the central axis. Each ear has a proximal edge 16PE on a line perpendicular to the central axis. The upper and lower contact areas 16C, 16E on the board proximal end portion 16P extend right to the proximal edges 16PE. Referring to FIG. 2A, both grooves 18 are fully plated inasmuch as both the base 18B and the side walls 18S of each groove are conductively coated and electrically continuous with the conductive sleeve 14.

Connections between the shielded transmission line formed by the intermediate portion 16I of the elongate laminate board 16 and the antenna element structure are completed by the lateral laminate board part 20, shown in FIG. 2A. The slot 20S in the lateral laminate board part 20 has elongate side walls 20SW which are each plated (only one such plated wall 20SW is visible in FIG. 2A), each plated side wall 20SW being connected to a respective segment-shaped inner plated area 201 on the proximal face 20PF of the laminate board part 20.

On each side of the slot, the lateral laminate board part 20 has arcuate peripheral conductor areas 20P extending over the side edges of the board part 20. Embodied in and/or carried by the lateral laminate board part 20 are circuit elements (not shown) interconnecting the conductors associated with the slot side walls 20SW and the peripheral conductor areas 20P. In the absence of an impedance matching network on the elongate laminate board 16, these circuit elements may constitute an impedance matching network of the kind disclosed in U.S. Pat. No. 7,439,934, the entire contents of which are incorporated herein by reference.

In the assembled antenna, solder joints are formed between the distal connection areas 27D, 29 of the feed line inner conductor and shield conductors, respectively, the side walls 20SW of the slot 20S. Solder joints between the peripheral conductor areas 20P of the lateral laminate board part 20 and the conductors on the distal end surface portion 12D of the core, specifically the arcuate interconnections 10AB, 10CD, together with the above-described connections between the laminate board 16 and the lateral laminate board part 20, result in the connection of the shielded transmission line formed by the laminate board intermediate portion 16I to the antenna element structure.

Referring to FIGS. 2A and 2B in conjunction with FIGS. 1A and 1B, during assembly of the antenna the elongate laminate board 16 is inserted in the bore 12B of the antenna core 12 so that the proximal edges 16PE of the lateral ears abut the bases 18B of the respective grooves 18 in the proximal end portion of the core 12. The grooves 18 are centred on a diameter containing the central axis of the antenna and have side walls 18S which are inclined with respect to the plane containing that diameter and the antenna axis so that the grooves 18 are tapered, i.e. narrower at their base 18B than at their mouths. The width of the grooves at their bases 18B matches the thickness of the laminate board 16 so that when the laminate board proximal end portion 16P is fully inserted in the grooves 18, the board 16 is secured against rotation relative to the core 12 and, hence, relative to the antenna elements 10A-10D. The distance between the proximal edges 16PE of the proximal end portion 16, on the one hand, and the extreme distal end of the board distal end portion 16D on the other hand is such that, when the proximal end portion 16P is fully seated in the groove 18, the distal end portion 16D projects by an amount approximately equal to the thickness of the lateral laminate board part 20.

During manufacture of the antenna, solder paste is deposited in the grooves 18 and on the distal end surface portion 12D of the core 12 so that, when the assembled components are passed through a reflow oven, the upper and lower conductive layers 16-1, 16-3 (FIG. 3) of the elongate laminate board 16 are electrically connected to the conductive plating in the grooves 18, including the plated groove base 18B in each case, and connections are also made between the lateral laminate board part 20 and the arcuate interconnecting conductors 10AB, 10CD (FIG. 2B) on the core distal end surface portion 12D. The connections between the elongate laminate board 16 and the lateral laminate board part 20 are also made at this stage. Referring to FIG. 4, it is preferred that sufficient solder paste is deposited in the grooves 18 such that, when the assembled antenna is heated, solder 31 fills the grooves on each side of the laminate board proximal end portion 16P and forms fillets 32 between the contact areas 16C, 16E on each side of the board proximal end portion 16P and the plated proximal end surface portion 12P of the core 12.

Electrically, the antenna behaves as a multifilar backfire helical antenna as described in a number of prior patent publications, including GB2310543, GB2311675 and WO2006/136809, the entire contents of all three of these publications being incorporated in the present specification by reference. As described in the prior publications, the primary mode of resonance of the antenna is a circularly polarised mode in which the sleeve 14 encircling the core 12, and the plating on the core end surface 12P, together with the feeder structure, form a quarter-wave balun so that currents flow around the rim 14R interconnecting the proximal ends of the helical antenna elements 10A-10D to produce a distally directed cardioid radiation pattern suited to reception and/or transmission of satellite signals when the antenna is oriented with its axis generally vertical. In this resonant mode, the resonant frequency is mainly determined by the lengths of the helical elements 10A-10D and the relative dielectric constant of the core material. The sleeve 14, in conjunction with the plated proximal end surface portion 12P, has a nominal electrical length equivalent to a quarter wavelength, although operation of the structure as a balun is tolerant of wide variations in this electrical length. Operation of the balun has the effect of balancing the antenna feed at the distal end of the transmission line formed by the intermediate laminate board portion 16I.

The antenna has a second mode of resonance also described in the above-mentioned GB2311675, in which currents flowing in the helical antenna elements 10A-10D, instead of being trapped at the sleeve rim 14R, flow longitudinally through the sleeve 14 and thence directly to the shield conductors of the feeder via the connections of the latter formed in the grooves 18. These currents flow along the outside of the shield formed by the shield conductors between the grooves 18 and the distal end of the transmission line so that a complete conductive loop is formed (a) through the connections made by the lateral laminate board part 20, (b) through the helical elements 10A-LOAD and the sleeve 14, (c) along the base of each groove 18, and (d) along the shield conductors of the feeder. The electrical length of this composite conductive path defines the frequency of the second mode of resonance, which is a resonance characterised by linearly polarised radiation, polarised in planes in containing the antenna axis. The associated radiation pattern is generally toroidal, i.e. with an omnidirectional maximum at zero elevation and vertical (axial) nulls.

The resonances of both resonant modes have associated harmonic resonances as well.

With regard to the linearly polarised mode of resonance, the electrical length of the composite conductive path defining the resonant frequency is dependent on the depth of the grooves 18 since the effective conductive length between the rim 14R of the sleeve 14 and the feeder shield decreases at the depth of the groove increases. In addition, as the depth of the groove increases, the effective length of the conductive path formed by the outside of the feeder shield decreases. Given the tolerance of the circularly polarised mode of resonance to changes in the effective length of the sleeve 14, it is possible to alter the resonant frequency of the linearly polarised mode by varying the depth of the grooves 18. It is appropriate to vary the axial depth of the lateral extensions or ears of the laminate board proximal end portion 16P accordingly (by increasing or decreasing the distance between the proximal edges of the proximal end portion 16P and the distal end of the laminate board 16 so that the axial positions of the distal and proximal ends of the laminate board 16 relative to the proximal and distal end surface portions 12P, 12D of the core 12 are maintained constant).

Accordingly, manufacture of antennas in accordance with embodiments of the disclosed technology is performed by providing a range of antenna bodies, each consisting of a core 12 with the plated antenna structure, in which the groove depth d_{G} (FIG. 2A) is different from antenna body to antenna body, the overall length and diameter of the antenna body remaining constant. Similarly, a corresponding range of elongate laminate boards 16 is provided, having proximal end portions 16P of different depths d_{P} (FIG. 2A). In other words, the elongate laminate boards 16 are provided with intermediate portions 16I of different lengths d_{I}.

To assemble the antenna described above with reference to FIGS. 1A, 1B, 2A, 2B and 3, an antenna body with grooves 18 of a first depth d_{G} is selected together with a laminate board 16 of a matching proximal end portion depth d_{P}. If an antenna with a linearly polarised resonant mode of lower frequency is required, then an antenna body in which the depth of the groove 18 is less is selected, i.e. depth d_{G1}, as shown in FIGS. 1C, 1D, 2C, and 2D. An elongate laminate board 16 with a longer intermediate portion 16I (length d_{II}), and a proximal end portion 16P of smaller axial extent d_{P1} is then selected. In this instance, the relevant conductive path length is greater, since the effective depth of the sleeve 14 is greater and the effective length of the outside of the shield conductors is greater, yielding the required lower resonant frequency.

Maintenance of the other dimensions of the antenna bodies and laminate boards leads to economies both in the production of the antennas and in their mounting in, e.g. equipment sub-assemblies and housings.

In the preferred embodiments herein described and shown, the resonant frequency of the linearly polarised resonant mode is higher than that of the circularly polarised resonance mode, this relationship being in respect of resonances at the respective fundamental frequencies of resonance. This is achieved in part as a result of the spacing of the feeder shield conductors from the wall of the bore 12B, thereby reducing the dielectric elongation of the electrical length of the shield conductors.

The above-described antenna embodiments are quadrifilar helical antennas. Falling within the scope of the disclosed technology are antennas other than quadrifilar helical antennas. For instance, antennas with cuboid-shaped dielectric cores may be used, as well as helical antennas with different numbers of helical elements. Such antennas include hexafilar and octafilar antennas as described in, for instance, GB2445478A, the disclosure of which is incorporated herein by reference.

What is claimed is:

1. An antenna for operation at a frequency in excess of 200 MHz comprising:
an insulative substrate having a central axis, an axial passage extending therethrough and an outer substrate surface which extends around the axis;
a three-dimensional antenna element structure including at least one pair of axially coextensive elongate conductive antenna elements on or adjacent the outer substrate surface; and
an axial feeder structure which extends through the passage and comprises an elongate laminate board having a proximal end portion for connection to host equipment circuitry, an intermediate portion including a transmission line, and a distal end portion coupled to the antenna elements;
wherein the laminate board proximal end portion is wider than the intermediate portion in that it includes lateral extensions projecting in opposite lateral directions, and wherein, adjacent the laminate board proximal end portion, the substrate has recesses on opposite sides of the axis which receive at least edge parts of said lateral extensions of the laminate board proximal end portion.

2. An antenna according to claim 1, wherein:
the substrate comprises a dielectric core of solid material which has a relative dielectric constant greater than 5 and occupies the major part of the interior volume defined by the core outer surface, the core outer surface comprising oppositely directed distal and proximal outer surface portions and a side outer surface portion extending between the distal and proximal surface portions;
the axial passage extends through the core from the distal outer surface portion to the proximal outer surface portion; and
the recesses comprise grooves in the proximal outer surface portion of the core.

3. An antenna according to claim 2, wherein the core is cylindrical, the elongate conductive antenna elements comprise helical elements on the side outer surface portion of the core, the side outer surface portion carries a plated proximal sleeve linking proximal ends of the helical elements, and the proximal outer surface portion and the grooves have a conductive coating connected to the sleeve, and
wherein the feeder structure transmission line includes a conductor which is connected to the conductive coating of the core proximal outer surface portion via electrical interconnection of a conductive layer on at least one of the laminate board lateral extensions and the conductive layer in the respective groove which houses that lateral extension.

4. An antenna according to claim 1, wherein the intermediate portion of the laminate board comprises an inner conductive layer forming an elongate inner conductor of the transmission line, and, on opposite sides of the inner conductive layer, interconnected shield conductor layers thereby to form a shield for the inner conductor, and wherein the antenna element structure includes an annular interconnecting conductor linking the proximal ends of said elongate conductive antenna elements, and the feeder shield conductors are connected to the annular interconnecting conductor at an axial position corresponding to the base of the respective recess.

5. An antenna according to claim 1, wherein the width of at least one of the recesses matches the thickness of the laminate board proximal end portion thereby to define the rotational position, about the central axis, of the feeder structure relative to the substrate.

6. An antenna according to claim 1, wherein the recesses are shaped and dimensioned to secure the laminate board against rotation about the central axis.

7. An antenna according to claim 1, wherein the feed structure further comprises a lateral laminate board part connected to said elongate laminate board and extending laterally from the distal end of the axial passage, conductors on the lateral laminate board part coupling the antenna elements to the transmission line.

8. An antenna according to claim 7, wherein the lateral laminate board part comprises a laminate board oriented perpendicularly to the central axis.

9. An antenna according to claim 7, wherein the feed structure includes a distal matching network.

10. An antenna according to claim 4, wherein the substrate comprises a dielectric core of solid material which has a relative dielectric constant greater than 5 and occupies a major part of the interior volume defined by the core outer surface, the core outer surface comprising oppositely directed distal and proximal surface portions and a side surface portion extending between the distal and proximal surface portions, and wherein the axial passage extends through the core from the distal surface portion to the proximal surface portion, the dimensions of the passage and the shield conductors of the feeder being such that the shield conductors are spaced from the wall of the passage.

11. An antenna according to claim 4, having first and second operating frequencies in excess of 200 MHz associated respectively with circular polarisation and linear polarisation modes of resonance of the antenna, wherein the frequency of the circular polarisation mode of resonance is determined primarily by the electrical lengths of said elongate antenna elements and that of the linear polarisation mode of resonance is determined by the electrical lengths of said elongate antenna elements and that of the conductive path which is formed between the proximal ends of said elongate elements and the distal end of the transmission line and which includes the feeder shield.

12. An antenna according to claim 4, having first and second operating frequencies in excess of 200 MHz associated respectively with first and second modes of resonance, wherein the first mode is characterised by a rotating dipole and the second is a coaxial monopole mode.

13. An antenna according to claim 11, wherein the second operating frequency is higher than the first operating frequency.

14. An antenna according to claim 13, wherein first and second operating frequencies are in the region of 1575 MHz and 2450 MHz respectively.

15. A method of making a multiple-band antenna for operation at frequencies in excess of 200 MHz comprising:
providing a plurality of antenna bodies each of which comprises (i) an insulative antenna substrate having a central axis, an axial passage extending therethrough, and an outer substrate surface extending around the axis, the outer substrate surface having distal periphery and proximal periphery, (ii) a three-dimensional antenna element structure including at least one pair of axially coextensive elongate conductive antenna elements on the outer substrate surface, and (iii) a linking conductor encircling the axis on the outer substrate surface and interconnecting proximal ends of the said antenna elements, wherein the substrate has proximal recesses on opposite sides of the axis, the recesses extending into the linking conductor to reduce its effective axial extent, wherein the plurality of antenna bodies have the same axial extent, as determined by the distance between the distal and proximal peripheries, but recesses of different respective depths;
providing a plurality of feeder structures each comprising an elongate laminate board having a proximal end portion for connection to host equipment circuitry, an intermediate portion including a transmission line and dimensioned to lie in the substrate passage, and a distal end portion for coupling to antenna elements, the proximal end portion having lateral extensions projecting in opposite lateral directions, wherein the plurality of feeder structures have intermediate portions of different lengths;
selecting one of the antenna bodies and one of the feeder structures;
inserting the selected feeder structure into the axial passage of the selected antenna body with said lateral extensions of the laminate board proximal end portion seated in the proximal recesses of the antenna body substrate; and
forming electrical connections between the antenna elements and the laminate board distal end portion and between the linking conductor and the lateral extensions of the laminate board proximal end portion.
